(19) United States
(12) Patent Application Publication
(10) Pub. No.: US 2007/0052866 A1
(43) Pub. Date: Mar. 8, 2007

(54) Video processing apparatus and video processing method

(75) Inventor: Simon Bae, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/514,954

(22) Filed: Sep. 5, 2006

(30) Foreign Application Priority Data
Sep. 8, 2005 (KR) 10-2005-0083790

(51) Int. Cl. H04N 5/50

(52) U.S. Cl. 348/731

(57) ABSTRACT

Disclosed are a video processing apparatus and method. The apparatus includes: a video processing unit; an information storage unit storing video information on a video signal and channel information on a plurality of channels corresponding to the video information; a signal evaluating unit evaluating receiving quality of the video signal; and a controller controlling the video processing unit, if the receiving quality of the video signal in the channel selected by a user is less than a predetermined value, to process the video signal of another channel having the same video information as the selected channel based on the channel information stored in the information storage unit.

### CROSS-REFERENCE TO RELATED APPLICATIONS

This application claims the benefit of Korean Patent Application No. 2005-0083790, filed on Sep. 8, 2005, in the Korean Intellectual Property Office, which is hereby incorporated by reference for all purposes as if fully set forth herein.

### BACKGROUND OF INVENTION

1. Field of Invention

The present invention relates to a video processing apparatus and a video processing method, and more particularly, to a video processing apparatus and a video processing method which processes a video signal of a channel having good quality among channels having the same video information and displays the processed video signal.

2. Description of the Related Art

A video processing apparatus such as a TV or a set-top box receives a video signal having a predetermined video and video-processes the received video signal and outputs the video. The video processing apparatus may receive the video signal through various routes. For example, the video processing apparatus may receive a variety of channels, each of which has a video signal that has the same contents. Examples of a channel through which the video signal is received are a broadcasting channel that broadcasts a digital terrestrial broadcast according to a digital TV standard such as an advanced television systems committee (ATSC) and the like, a cable channel, and an internet protocol (IP) TV channel broadcasting from a plurality of base stations or channels.

If the user selects the channel without consideration of video quality in channels having the same contents, a video signal of a channel having poor quality may be processed. In addition, a provided video signal may be used ineffectively. For example, if a normal video signal is not received due to problems associated with the transmitting of signals from a broadcasting station or due to problems with a network cable in a cable system, either no signal or a weak signal may be displayed. Accordingly, the user will not see a satisfactory signal until the normal video signal is received.

### SUMMARY OF THE INVENTION

Accordingly, it is an aspect of the present invention to provide a video processing apparatus and a video processing method which processes a video signal of a channel having good quality among channels having the same video and displays the processed video signal.

Additional features of the invention will be set forth in the description which follows, and in part will be apparent from the description, or may be learned by practice of the invention.

The foregoing and/or other aspects of the present invention can be achieved by providing a video processing apparatus comprising: a controller which receives receiving quality information of a video channel being processed and if the receiving quality information is less than a predetermined value, outputs a signal indicating that the channel being processed should be changed to another channel having video information which is the same as video information of the channel being processed, and otherwise continues processing the channel being processed.

According to an aspect of the invention, the video processing apparatus may also include a signal evaluating unit which evaluates receiving quality of a video signal and, based on the evaluating, outputs the receiving quality information.

According to an aspect of the invention, the signal evaluating unit may calculate a loss rate of data in the video signal for a predetermined time to evaluate the receiving quality.

According to an aspect of the invention, the signal evaluating unit may calculate error correction time of data in the video signal to evaluate the receiving quality.

According to another aspect of the invention, the video processing unit may also include an information storage unit which stores video information on a video signal and channel information on a plurality of channels corresponding to the video information.

According to another aspect of the invention, the video processing unit may also include a video processing unit which processes the video signal and in response to the controller outputting the signal indicating that the channel being processed should be changed, changes processing to another channel having video information which is the same as video information of the channel being processed.

The foregoing and/or other aspects of the present invention can be achieved by providing a video processing method comprising: video-processing a video signal of a first channel; and inputting receiving quality information on a video signal in the first channel and, if the receiving quality information of the video signal in the first channel is less than a predetermined value, video processing a video signal of a second channel having video information that is the same as the video information of the first channel.

In an aspect of the invention the video processing method may further include evaluating receiving quality of the video signal in the first channel to generate the receiving quality information.

In another aspect of the invention, the video processing method may include storing information on the video signals of at least the first channel and the second channel and channel information on at least the first channel and the second channel corresponding to the information on the video signals.

In another aspect of the invention, the evaluating the receiving quality may comprise calculating a loss rate of data in the video signal of the first channel for a predetermined time.

In another aspect of the invention, the evaluating the receiving quality may comprise calculating error correction time of data in the video signal of the first channel.

It is to be understood that both the foregoing general description and the following detailed description are exemplary and explanatory and are intended to provide further explanation of the invention as claimed.

### BRIEF DESCRIPTION OF THE DRAWINGS

These and other aspects, features, and advantages of certain embodiments of the present invention will be more apparent and more readily appreciated from the following detailed description, taken with reference to the accompanying drawings, in which:

FIG. 1 is a schematic block diagram of a configuration in a video processing apparatus according to an embodiment of the present invention;

FIG. 2 is a drawing illustrating a table explaining video information and channel information stored in a memory according to an exemplary embodiment of the present invention;

FIG. 3 is a schematic flow chart illustrating an operation of a video processing apparatus according to an exemplary embodiment of the present invention.

FIG. 4 is a schematic flow chart illustrating an operation of a video processing apparatus according to an exemplary embodiment of the present invention.

FIG. 5 is a schematic flow chart illustrating an operation of a video processing apparatus according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout.

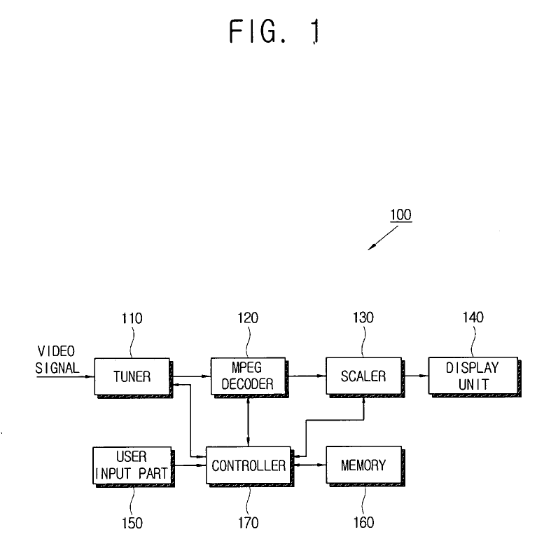

FIG. 1 is a schematic block diagram of a configuration in a video processing apparatus 100 according to an exemplary embodiment of the present invention. The video signal apparatus 100 according to the embodiment receives a video signal comprising a certain video broadcast according to a digital TV standard or the like from a broadcasting station and video-processes the received video signal and outputs a video. The video signal apparatus 100 tunes the video signal according to a channel selected by a user to a predetermined frequency which is allotted in advance and receives the tuned signal. The video signal apparatus 100 evaluates the receiving quality of the received video signal. If the evaluated receiving quality is less than a predetermined value, the video signal apparatus 100 converts the present selected channel to another channel having the same video information and video-processes the video signal in the converted channel.

As shown in FIG. 1, the video signal apparatus 100 comprises a tuner 110, an MPEG decoder 120, a scaler 130, a display unit 140, a user input part 150, a memory 160 and a controller 170. The tuner 110 tunes and receives the video signal based on a frequency corresponding to a predetermined channel according to a control of the controller 170. Video signals having the same video may be received through a plurality of channels by the tuner 110. The video signal according to the present embodiment is a digital broadcasting signal. The MPEG decoder 120 decodes the video signal received by the tuner 110 and then extracts information about the video contained in the video signal. The MPEG decoder 120 according to the present embodiment is operated according to a moving pictures experts group (MPEG)-2 standard and decodes data of the video signal from a transport stream. The user input part 150 receives information such as a channel selection and the like from the user and transfers the information to the controller 170. The user input part 150 may be a device such as a remote control. The scaler 130 scales, that is, adjusts the resolution of, the video information decoded by the MPEG decoder 120 according to the control of the controller 170 and displays the video having a suitable size on the display unit 140. The display unit 140 displays the video based on the scaled video information and may be a cathode ray tube (CRT), a liquid crystal display (LCD), a plasma display panel (PDP) or other device capable of displaying a video signal.

The MPEG decoder 120 according to the present embodiment evaluates the quality of the received video signal. The MPEG decoder 120 according to the present embodiment calculates a loss rate in which loss of data corresponding to a “sync byte” of a transport stream header among MPEG-2 transport stream packets is calculated for a predetermined time, and thereby evaluates the quality of the received video signal. The “sync byte” is an 8-bit field located in the front of an MPEG-2 transport stream header and is a value of “01000111” in the binary system (that is “0×47” in the hexadecimal system). The MPEG decoder 120 determines whether or not a value of data corresponding to the “sync byte” of each MPEG-2 transport stream header in the transport stream packets is the value of “01000111” and calculates the loss rate. The MPEG decoder 120 according to the present embodiment is an example of a signal evaluating part according to the present invention.

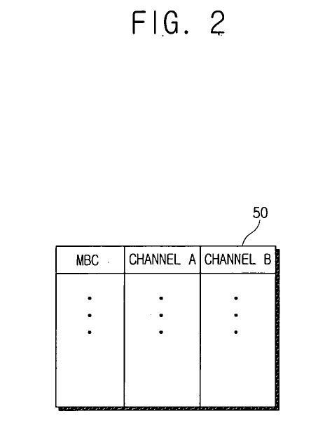

The video information and channel information of a plurality of channels corresponding to the video information are stored in the memory 160 as a database (DB). FIG. 2 shows a table 50 with the video information and channel information stored in the memory 160. In the table 50 of FIG. 2, “MBC” denotes a source of the video information, such as the name of a broadcasting station. “Channel A” and “channel B” denote the channel information of the plurality of channels corresponding to the “MBC”. In the memory 160 of the present embodiment, the video information and the channel information of the plurality of channels corresponding to the video information may be stored by the controller 170. In this case, the video information may comprise a transport stream identifier (TSID) capable of identifying the video information. The controller 170 identifies the TSID referring to a program and system information protocol (PSIP) of the video signal according to the ATSC standard to identify video signals having the same video information in the video signal. The memory 160 of the present embodiment is an example of an information storage unit.

If the controller 170 determines that the loss rate of the data evaluated by the MPEG decoder 120 is greater than a predetermined reference value, the controller 170 converts the selected channel to another channel having the same video information. Referring to FIG. 2, for example, in case the “channel A” is selected by the user, if the controller 170 determines that the loss rate of the data evaluated by the MPEG decoder 120 is greater than the predetermined reference value, the controller 170 controls the tuner 110 and the MPEG decoder 120 to video-process with respect to the “channel B” which is another channel having the same video information as the “channel A”. The controller 170 may comprise a microprocessor such as a CPU and a program operated by the microprocessor.

On the other hand, if an error of the data in the received video signal has occurred, the MPEG decoder 120 corrects the error. In addition, the MPEG decoder 120 calculates error correction time required to correct the error to evaluate the receiving quality of the video signal. If the controller 170 determines that the loss rate of the data evaluated by the MPEG decoder 120 is greater than the predetermined reference value and the error correction time calculated by the MPEG decoder 120 is more than a predetermined reference time, the controller 170 converts the present selected channel to another channel having the same video information.

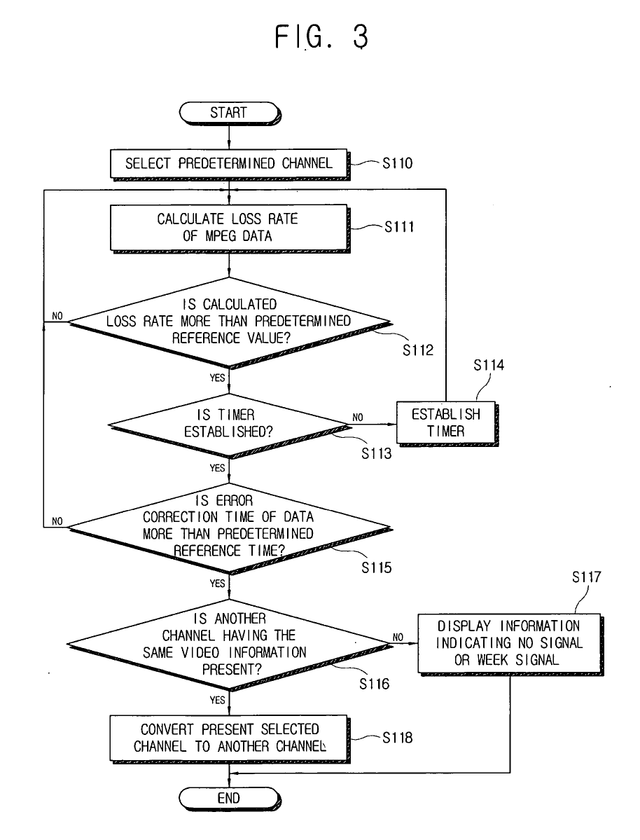

FIG. 3 is a schematic flow chart illustrating an operation of the video processing apparatus 100 according to the embodiment of the present invention. First, a predetermined channel is selected by the user so that the video processing apparatus 100 tunes the selected channel to a corresponding frequency and receives the video signal of the corresponding channel (S100). The video processing apparatus 100 calculates the loss rate of the MPEG data about the video signal in the received channel (S111). If the video processing apparatus 100 determines that the calculated loss rate is greater than the predetermined reference value (S112), the video processing apparatus 100 maintains the present channel. While the video processing apparatus 100 video-processes the received video signal and displays the video, the video processing apparatus 100 continuously calculates the loss rate of the MPEG data (S111).

If the video processing apparatus 100 determines that the calculated loss rate is more than the predetermined reference value (S112), the video processing apparatus 100 determines whether or not a timer for determining the error correction time is established. If the video processing apparatus 100 determines that the timer is not established (S113), the video processing apparatus 100 establishes the timer (S114) and then calculates the loss rate of the MPEG data (S111). If the video processing apparatus 100 determines that the timer is established (S113), the video processing apparatus 100 determines whether or not the error correction time of the data is more than the predetermined reference time (S115). If video processing apparatus 100 determines that the error correction time of the data is not more than the predetermined reference time (S115), the video processing apparatus 100 maintains the present channel. While the video processing apparatus 100 video-processes the received video signal and displays the video, the video processing apparatus 100 continuously calculates the loss rate of the MPEG data (S111).

If the video processing apparatus 100 determines that the error correction time of the data is greater than the predetermined reference time (S115), the video processing apparatus 100 refers to the DB in the memory 160 to determine whether or not another channel having the same broadcasting or the same video information as the present selected channel is present (S116). If the video processing apparatus 100 determines that another channel having the same video information is not present (S116), the video processing apparatus 100 displays information on the display unit 140 indicating that there is no signal or a week signal (S117). If the video processing apparatus 100 determines that another channel having the same video information is present (S116), the video processing apparatus 100 converts the present selected channel to another channel having the same video information and receives the video signal of the converted channel and thus video-processes and displays the converted channel (S118).

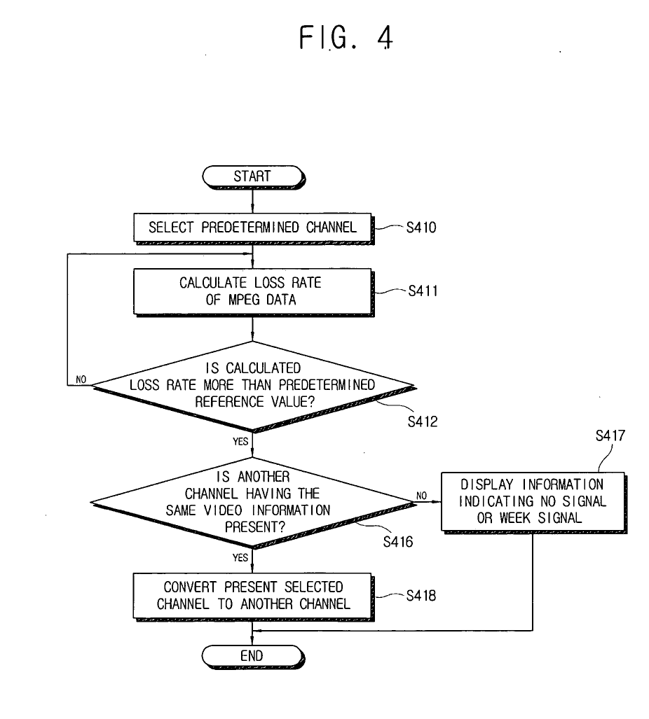

FIG. 4 is a schematic flow chart illustrating an operation of the video processing apparatus 100 according to another exemplary embodiment of the present invention. First, a predetermined channel is selected by the user so that the video processing apparatus 100 tunes the selected channel to a corresponding frequency and receives the video signal of the corresponding channel (S410). The video processing apparatus 100 calculates the loss rate of the MPEG data about the video signal in the received channel (S411). If the video processing apparatus 100 determines that the calculated loss rate is greater than the predetermined reference value (S412), the video processing apparatus 100 maintains the present channel. While the video processing apparatus 100 video-processes the received video signal and displays the video, the video processing apparatus 100 continuously calculates the loss rate of the MPEG data (S411).

If the video processing apparatus 100 determines that the calculated loss rate per second is greater than the predetermined reference value (S412), the video processing apparatus 100 refers to the DB in the memory 160 to determine whether or not another channel having the same broadcasting or the same video information as the present selected channel is present (S416). If the video processing apparatus 100 determines that another channel having the same video information is not present (S416), the video processing apparatus 100 displays information on the display unit 140 indicating that there is no signal or a week signal (S417). If the video processing apparatus 100 determines that another channel having the same video information is present (S416), the video processing apparatus 100 converts the present selected channel to another channel having the same video information and receives the video signal of the converted channel and thus video-processes and displays the converted channel (S418).

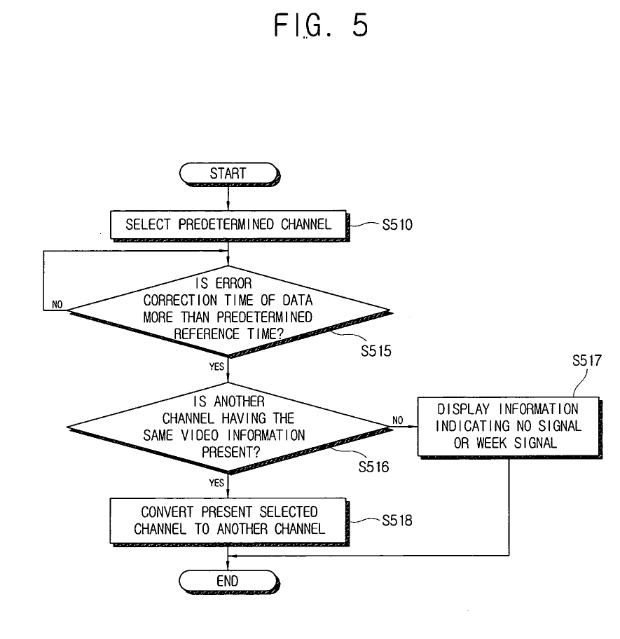

FIG. 5 is a schematic flow chart illustrating an operation of the video processing apparatus 100 according to another exemplary embodiment of the present invention. First, a predetermined channel is selected by the user so that the video processing apparatus 100 tunes the selected channel to a corresponding frequency and receives the video signal of the corresponding channel (S510). Then the video processing apparatus 100 determines whether or not the error correction time of the data is more than the predetermined reference time (S515). If video processing apparatus 100 determines that the error correction time of the data is not more than the predetermined reference time (S515), the video processing apparatus 100 maintains the present channel.

If the video processing apparatus 100 determines that the error correction time of the data is greater than the predetermined reference time (S515), the video processing apparatus 100 refers to the DB in the memory 160 to determine whether or not another channel having the same broadcasting or the same video information as the present selected channel is present (S516). If the video processing apparatus 100 determines that another channel having the same video information is not present (S516), the video processing apparatus 100 displays information on the display unit 140 indicating that there is no signal or a week signal (S517). If the video processing apparatus 100 determines that another channel having the same video information is present (S516), the video processing apparatus 100 converts the present selected channel to another channel having the same video information and receives the video signal of the converted channel and thus video-processes and displays the converted channel (S518).

It will be apparent to those skilled in the art that various modifications and variations can be made in the present invention without departing from the spirit or scope of the invention. Thus it is intended that the present invention cover the modifications and variations of this invention provided they come within the scope of the appended claims and their equivalents.

What is claimed is:

1. A video processing apparatus comprising:
a controller which receives receiving quality information of a video channel being processed and if the receiving quality information is less than a predetermined value, outputs a signal indicating that the channel being processed should be changed to a second channel having video information which is the same as video information of the channel being processed, and otherwise continues processing the channel being processed.

2. The video processor of claim 1, further comprising:
a signal evaluating unit which evaluates receiving quality of a video signal and, based on the evaluating, outputs the receiving quality information.

3. The video processor of claim 2, wherein the signal evaluating unit calculates a loss rate of data in the video signal for a predetermined time to evaluate the receiving quality.

4. The video processing apparatus according to claim 2, wherein the signal evaluating unit calculates error correction time of data in the video signal to evaluate the receiving quality.

5. The video processor of claim 1, further comprising:
an information storage unit which stores video information on a video signal and channel information on a plurality of channels corresponding to the video information.

6. The video processor of claim 1, further comprising:
a video processing unit which processes the video signal and in response to the controller outputting the signal indicating that the channel being processed should be changed, changes processing to the second channel having video information which is the same as video information of the channel being processed.

7. A video processing method comprising:
video-processing a video signal of a first channel; and
inputting receiving quality information on a video signal in the first channel and, if the receiving quality information of the video signal in the first channel is less than a predetermined value, video processing a video signal of a second channel having video information that is the same as the video information of the first channel.

8. The video processing method of claim 7, further comprising:
evaluating receiving quality of the video signal in the first channel to generate the receiving quality information.

9. The video processing method according to claim 8, wherein the evaluating the receiving quality comprises calculating a loss rate of data in the video signal of the first channel for a predetermined time.

10. The video processing method according to claim 8, wherein the evaluating the receiving quality comprises calculating error correction time of data in the video signal of the first channel.

11. The video processing method of claim 7, further comprising:
storing information on the video signals of at least the first channel and the second channel and channel information on at least the first channel and the second channel corresponding to the information on the video signals.
